SEQUENCE LISTING (3 sequences)

SEQ ID NO: 1 - protein, 9 aa, Gallus gallus
GTDVQAWIR

SEQ ID NO: 2 - protein, 8 aa, Bos taurus
LDQWLCEK

SEQ ID NO: 3 - protein, 16 aa, Gallus gallus
ELINSWVESQTNGIIR

(19) United States
(12) Patent Application Publication
(10) Pub. No.: US 2005/0224710 A1
(43) Pub. Date: Oct. 13, 2005

(54) Method for measuring hydrophobic peptides using maldi mass spectrometer

(76) Inventors: Eiichi Matsuo, Kyoto-shi (JP); Makoto Watanabe, Osaka (JP); Noriyuki Ojima, Kyoto-shi (JP); Chikako Toda, Kyoto-shi (JP); Hiroki Kuyama, Kyoto-shi (JP); Osamu Nishimura, Kawanishi-shi (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 11/028,216

(22) Filed: Jan. 4, 2005

(30) Foreign Application Priority Data
Apr. 13, 2004 (JP) 2004-118343

(51) Int. Cl. H01J 49/16

(52) U.S. Cl. 250/288

(57) ABSTRACT

The present invention provides a method capable of efficiently ionizing hydrophobic peptides in MALDI-IT, MALDI-IT-TOF, and MALDI-FTICR mass spectrometers. A method of measuring a peptide with a mass spectrometer having a MALDI (Matrix Assisted Laser Desorption/Ionization) ion source, using α-cyano-3-hydroxycinnamic acid or 3-hydroxy-4-nitrobenzoic acid as a matrix. Preferably, a peptide derivatized with 2-nitrobenzenesulfenyl chloride is measured with a MALDI-IT, MALDI-IT-TOF, or MALDI-FTICR mass spectrometer. When 3-hydroxy-4-nitrobenzoic acid is used as a matrix, the matrix is preferably used as a mixed matrix in which α-cyano-4-hydroxycinnamic acid is combined.

### BACKGROUND OF THE INVENTION

1. Field of the Invention

The present invention relates to a field of proteome analysis using a mass spectrometer.

2. Disclosure of the Related Art

<Quantitative Analysis>

In the field of proteome analysis (global analysis of protein), a PMF (Peptide Mass Finger Printing) analysis method in which a two-dimensional gel electrophoresis and a mass spectrometer are combined has been commonly used. As a next-generation proteome analysis method which will be an alternative to the PMF, approaches using stable isotopes have been proposed. For example, Salvatore Sechi and Yoshiya Oda, Quantitative proteomics using mass spectrometry, Current Opinion in Chemical Biology, 2003, 7, 70-77 discloses a quantitative proteomics using the mass spectrometry using an ICAT (Isotope-Coded Affinity Tag) reagent. Disclosed in Hiroki Kuyama, Makoto Watanabe, Chikako Toda, Eiji Ando, Koichi Tanaka and Osamu Nishimura, An Approach to Quantitative Proteome Analysis by Labeling Tryptophan Residues, Rapid Communications in Mass Spectrometry, 2003, 17, 1642-1650 and international publication WO 2004/002950 pamphlet is a method developed by the present inventors (this method is hereinafter referred to as “NBS method”), including: modifying a tryptophan residue in a protein or a peptide with stable isotope-labeled and non-labeled 2-nitrobenzenesulfenyl chloride (NBSCl) serving as a labeling reagent; enzymatically digesting the resultant protein or peptide with trypsin to obtain a peptide mixture; enriching peptides having nitrobenzenesulfenyl (NBS)-modified tryptophan from the peptide mixture, using hydrophobic column chromatography technique; and conducting a quantitative analysis.

<Sequencing by MS/MS Analysis>

In the PMF method, mass values of a plurality of peptide fragments obtained by enzymatic digestion of one protein are detected by mass spectrometer, and the mass values are compared with a set of mass values of theoretical segments on the database, whereby the protein is identified. In contrast, in the NBS method, an original protein is identified by subjecting labeled and enriched peptides to a MS/MS analysis to determine their sequences and searching the database for proteins containing such sequences. Accordingly, in the NBS method, the sequencing by the MS/MS analysis is essential process for identifying a protein in addition to the quantitative analysis by commonly-used mass spectrometry.

The MS/MS analysis is performed by the three steps:
1) selection of a peptide to be sequenced, referred to as “precursor ion”; 2) fragmentation of the selected precursor ion; and 3) detection of mass values of resultant fragment ions. Examples of the mass spectrometer capable of conducting such a MS/MS analysis include: a tandem mass spectrometer having two mass separation units connected with each other, dedicated to selection of precursor ion and to detection of fragment ion; mass spectrometer utilizing decay by the own internal energy of ion (PSD: post-source decay); ion trapping mass spectrometer capable of conducting MS analysis more than once (MSⁿ analysis) by trapping ions; and FTICR mass spectrometer generating mass spectrometric signals through FT (Fourier transform) of data obtained by using the ion cyclotron resonance (ICR) technique.

In a matrix assisted laser desorption/ionization (MALDI) mass spectrometers, molecules (generally organic compounds) called matrix mixed with an analyte are heated by absorption of energy of a laser beam, vaporized and ionized. Instant vaporization of the matrix surrounding analyte molecules brings as a result the analyte molecules as well released into a gas phase almost concurrently. At this time, electrons or protons are transferred between the analyte molecule and the matrix, and thus the ionization of analyte molecule is achieved. Concurrently, the energy is partially transferred to the analyte molecule as internal energy.

As described above, the matrix also serves as a dispersing agent for the analyte molecule, while assisting vaporization and ionization of the analyte molecule. Therefore, affinity between matrix and analyte molecule would be important for ionization of the sample molecule with high efficiency. For this reason, an optimum organic compound for each analyte has been searched and used. For example, in measurement of a peptide, α-cyano-4-hydroxycinnamic acid (4-CHCA) is widely and generally used.

In the MALDI-IT (Matrix Assisted Laser Desorption/Ionization—Ion Trap) mass spectrometer, MALDI-IT-TOF (Matrix Assisted Laser Desorption/Ionization—Ion Trap—Time of Flight) mass spectrometer (for example, AXIMA-QIT (manufactured by SHIMADZU Corporation), and MALDI-FTICR (Matrix Assisted Laser Desorption/Ionization—Fourier Transform Ion Cyclotron Resonance) mass spectrometer, the analyte molecule that have been ionized by the MALDI method is enclosed once in a cell, and then detection and selection of ions or a MS/MS analysis is performed. Therefore, the time required for a generated ion to reach the detector and undergo measurement is more than two or three orders longer than that required in a usual MALDI-TOF (Matrix Assisted Laser Desorption/Ionization—Time of Flight) mass spectrometer. The ionized analyte molecules have excess internal energy, so that they self-disintegrate gradually. In a practical PSD measurement with a MALDI-TOF mass spectrometer, a pseudo MS/MS analysis is conducted based on this principle.

Therefore, in the MALDI-IT, MALDI-IT-TOF, and MALDI-FTICR mass spectrometers, considerable internal energy received during ionization will lead an unfavorable result that during measurement a number of undesired fragment ions are detected. From this point of view, using 4-CHCA as a matrix is not favorable in the MALDI-IT, MALDI-IT-TOF, and MALDI-FTICR mass spectrometers because excess internal energy will be applied on the analyte during ionization. Therefore, the matrix that is practically selected as a default in an AXIMA-QIT apparatus is 2,5-dihydroxy benzoic acid (DHB) which is believed to give relatively small energy on the analyte molecules during ionization.

### SUMMARY OF THE INVENTION

As described above, in the MALDI-IT, MALDI-IT-TOF, and MALDI-FTICR mass spectrometers, DHB is predominantly used as a matrix. However, in the case of measuring a sample containing hydrophobic peptides, the hydrophobic peptides cannot be effectively ionized even using the DHB.

It is an object of the present invention to provide a method capable of efficiently ionizing hydrophobic peptides in MALDI mass spectrometers, especially in MALDI-IT, MALDI-IT-TOF, and MALDI-FTICR mass spectrometers.

As a result of diligent research, the inventors have found that the above object of the present invention is achieved by using, as a matrix, a-cyano-3-hydroxycinnamic acid or 3-hydroxy-4-nitrobenzoic acid, and accomplished the present invention.

The present invention encompasses the following aspects.

(1) A method of measuring a peptide with a mass spectrometer having a MALDI (Matrix Assisted Laser Desorption/Ionization) ion source, using α-cyano-3-hydroxycinnamic acid or 3-hydroxy-4-nitrobenzoic acid as a matrix.

(2) The method of measuring a peptide according to the above (1), wherein when 3-hydroxy-4-nitrobenzoic acid is used as the matrix, the measuring is performed by using a mixed matrix of 3-hydroxy-4-nitrobenzoic acid and α-cyano-4-hydroxycinnamic acid.

(3) The method of measuring a peptide according to the above (1) or (2), wherein the peptide is a peptide that is chemically modified with a hydrophobic compound.

(4) The method of measuring a peptide according to any one of the above (1) to (3), wherein the peptide is a peptide that has an amino acid residue modified with a sulfenyl compound.

(5) The method of measuring a peptide according to any one of the above (1) to (4), wherein the peptide is a peptide that is derivatized with 2-nitrobenzenesulfenyl chloride.

The term “peptide” used herein should be understood to include oligopeptides, polypeptides, and proteins.

(6) The method of measuring a peptide according to any one of the above (1) to (5), performed by a MALDI-IT (Matrix Assisted Laser Desorption/Ionization—Ion Trap) mass spectrometer.

(7) The method of measuring a peptide according to any one of the above (1) to (5), performed by a MALDI-IT-TOF (Matrix Assisted Laser Desorption/Ionization—Ion Trap—Time of Flight) mass spectrometer.

(8) The method of measuring a peptide according to any one of the above (1) to (5), performed by a MALDI-FTICR (Matrix Assisted Laser Desorption/Ionization—Fourier Transform Ion Cyclotron Resonance) mass spectrometer.

(9) The method of measuring a peptide according to any one of the above (1) to (8), wherein the matrix is used as a solution having a concentration of 1 mg/ml to a saturated concentration.

(10) The method of measuring a peptide according to any one of the above (2) to (9), wherein the α-cyano-4-hydroxycinnamic acid is used as a solution having a concentration of 1 mg/ml to a saturated concentration.

(11) The method of measuring a peptide according to the above (10), wherein the solution of 3-hydroxy-4-nitrobenzoic acid and the solution of α-cyano-4-hydroxycinnamic acid are used in combination in a volume ratio of 1:10 to 10:1.

According to the present invention, it is possible to provide a method capable of efficiently ionizing hydrophobic peptides in MALDI mass spectrometers, especially in MALDI-IT, MALDI-IT-TOF, and MALDI-FTICR mass spectrometers.

### BRIEF DESCRIPTION OF THE DRAWINGS

FIG. 1 shows a MS spectrum (a) for comparison obtained by a conventional method, MS spectra (b) and (c) obtained by the method of the present invention in Example 1;

FIG. 2 shows a product-ion mass spectrum obtained in Example 1; and

FIG. 3 shows a MS spectrum (a-1) obtained by measuring with an AXIMA-QIT having an ion trap, and a MS spectrum (a-2) obtained by measuring with an AXIMA-CFR plus without an ion trap in Example 2(a); and a MS spectrum (b-1) obtained by using a mixture of 3H4NBA and 4-CHCA as a matrix and a MS spectrum (b-2) obtained by using 3H4NBA as a matrix in Example 2(b).

### DETAILED DESCRIPTION OF THE INVENTION

The present method is a method of measuring a hydrophobic peptide analyte using a mass spectrometer having a MALDI (Matrix Assisted Laser Desorption/Ionization) ion source. Ionization mechanism of the MALDI method is not completely elucidated at this time. Description of the present invention is based on the interpretation that is most widely accepted in the art.

In the present invention, the term “hydrophobic peptide” or “hydrophobic protein” refers to those having relatively high contents of hydrophobic amino acids, especially highly-hydrophobic amino acids, of the amino acid composition of such peptide or protein; those having the groups exemplified below; and those having chemical modifications as described below. Examples of the highly-hydrophobic amino acids include tryptophan, isoleucine, tyrosine, phenylalanine, leucine, valine, and methionine. Alanine, glycine, proline, and the like are also considered as hydrophobic amino acids in some cases.

The present invention is especially useful in measuring a hydrophobic peptide having a nitrobenzenesulfenyl group (NBS group: NO₂PhS group in which Ph represents a phenylene group), a nitrophenyl group, or the like. Examples of such a hydrophobic peptide include peptides containing a nitrotyrosine residue, a nitrophenylalanin residue, a tryptophan residue having a NBS group as a substituent, or a cysteine residue having a NBS group as a substituent.

The hydrophobic peptide may be obtained by chemically modifying a corresponding peptide with a hydrophobic compound. The corresponding peptide may itself be hydrophobic. In other words, the hydrophobic peptide may be derivatized into a peptide having higher hydrophobicity through chemical modification using a hydrophobic compound. Preferably, the hydrophobic compound is a sulpheyl compound. Sulfenyl compound is a compound that specifically modifies a tryptophan reside and a cysteine residue in a peptide or a protein. Particularly preferred examples of the sulfenyl compound include 2-nitrobenenesulfenyl chloride (NBS reagent). That is, an example of the hydrophobic peptide preferred in the present invention is those obtained by chemically modifying a peptide having a tryptophan residue or a cysteine residue using an NBS reagent.

The method of the present invention is particularly useful to mass spectrometers, combined with a MALDI ion source, in which the time required for a generated ion to reach a detector and undergo measurement is longer than that of a commonly-used MALDI-TOF mass spectrometer. Examples of such mass spectrometers include a MALDI-IT (Matrix Assisted Laser Desorption/Ionization—Ion Trap) mass spectrometer; a MALDI-IT-TOF (Matrix Assisted Laser Desorption/Ionization—Ion Trap—Time of Flight) mass spectrometer; and a MALDI-FTICR (Matrix Assisted Laser Desorption/Ionization—Fourier Transform Ion Cyclotron Resonance) mass spectrometer.

In the present invention, α-cyano-3-hydroxycinnamic acid (3-CHCA: Formula I below) or 3-hydroxy-4-nitrobenzoic acid (3H4NBA: Formula II below) is used as a matrix.

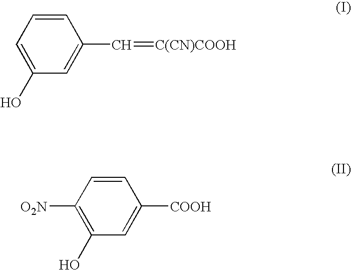

A person skilled in the art may appropriately determine the use form of these compounds in view of the use as a matrix for mass spectrometry. For example, these compounds are preferably used in a solution state. The concentration of the solution is not limited, for example, the solution may be used at a concentration of 1 mg/ml to a saturated concentration.

Preferred solvents used in preparing the above solution include an aqueous solution of acetonitrile, an aqueous solution of trifluoroacetic acid (TFA), or an aqueous solution of acetonitrile-trifluoroacetic acid (TFA). When the aqueous solution of acetonitrile or the aqueous solution of acetonitrile-TFA is used, the concentration of acetonitrile may be, but not limited to, not more than 90%, preferably about 50%. When the aqueous solution of TFA or the aqueous solution of acetonitrile-TFA is used, the concentration of TFA may be, but not limited to, not more than 1%, preferably about 0.1%.

When 3-CHCA is used as a matrix, 3-CHCA is dissolved in the above solvent and may be used as a matrix solution having a concentration of, for example, but not limited to, 1 mg/ml to a saturated concentration, preferably 10 mg/ml. When 3H4NBA is used as a matrix, 3H4NBA is dissolved in the above solvent and may be used as a matrix solution having a concentration of, for example, but not limited to, 1 mg/ml to a saturated concentration, preferably a saturated concentration.

The amount expressed as % in this description is on the basis of v/v % unless otherwise specified.

By using the matrix as described above, the following advantages are achieved.

As described above, in MALDI-IT mass spectrometer, MALDI-IT-TOF mass spectrometer, MALDI-FTICR mass spectrometer, and the like, the time required for a generated ion to reach the detector and undergo measurement is longer than that in a commonly-used MALDI-TOF mass spectrometer. In addition, the matrix is heated by receiving energy of a laser to be vaporized and ionized, and the energy partially becomes internal energy of the analyte molecules to cause gradual self-disintegration of ions. In other words, the longer the time required for a generated ion to reach the detector and undergo measurement, the more the self-disintegration proceeds, resulting that a number of undesired fragment ions will be detected. The matrix used in the present invention is believed to give smaller internal energy to the molecules to be measured during ionization, compared to the matrix in conventional methods (for example, the method in which only 4-CHCA is used as a matrix). Therefore, even if it is used in a mass spectrometer in which a generated ion requires a long time to reach the detector and undergo measurement as described above, it is possible to suppress the progression of self-disintegration of generated ions.

For this reason, the present invention is especially useful in a mass spectrometer in which a time from ionization to detection of ion is relatively long such as an ion trap mass spectrometer. Therefore, it goes without saying that it is also useful in a mass spectrometer having no ion trap.

Furthermore, as is already mentioned, affinity between matrix and analyte molecule is an important factor in ionization. It is expected that a matrix having high hydrophobicity is well compatible with an analyte having high hydrophobicity, and a matrix having high hydrophilicity is well compatible with an analyte having high hydrophilicity. It is expected that 3-CHCA or 3H4NBA matrix used in the present invention has higher hydrophobicity than conventional matrixes (DHB, for example). On the other hand, it is expected that peptide analyte molecules to be measured in the present invention also have high hydrophobicity, so that they have high affinity with 3-CHCA or 3H4NBA as a matrix. As a result, it is expected that a peptide analyte and a matrix is easy to form uniform fine crystals, and effective ionization can be achieved.

In the present invention, when 3-hydroxy-4-nitrobenzoic acid (3H4NBA) is used as a matrix, 3H4NBA is preferably used as a mixed matrix in which 3H4NBA is combined with α-cyano-4-hydroxycinnamic acid (4-CHCA, Formula III below). 4-CHCA is a compound widely used as a matrix in mass spectrometric analysis of a peptide. (Hereinafter, a singularly used matrix in which the matrix is used without combining with 4-CHCA, and a mixed matrix in which 4-CHCA is used in combination are sometimes simply described as matrix.)

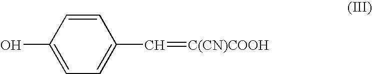

3H4NBA and 4-CHCA may be combined, for example, in the following quantitative relationship in a nonrestrictive manner.

For example, 3H4NBA may be prepared at a concentration as described above. Specifically, a 3H4NBA solution may be prepared as an aqueous solution having a concentration of 1 mg/ml to a saturated concentration; for example, when an aqueous solution of acetonitrile, an aqueous solution of TFA, or an aqueous solution of acetonitrile-TFA is used as a solvent, a 3H4NBA solution may be prepared as a solution having a concentration of 1 mg/ml to a saturated concentration, preferably a saturated concentration.

On the other hand, 4-CHCA may be prepared in such a concentration that is conventionally used. For example, it may be prepared as a solution having a concentration of 1 mg/ml to a saturated concentration. When an aqueous solution of acetonitrile, an aqueous solution of TFA, or an aqueous solution of acetonitrile-TFA same as used in preparing the 3H4NBA solution is used as a solvent, a 4-CHCA solution may be prepared as a solution having a concentration of 1 mg/ml to a saturated concentration, preferably 10 mg/ml.

The both of solution prepared in these manners are mixed in a volume ratio of, preferably 1:10 to 10:1, more preferably 1:3 to 3:1, for example 1:1 for use.

The conventional matrix 4-CHCA has a drawback that self-disintegration of an analyte to be measured occurs during measurement with a MALDI spectrometer such as MALDI-IT, MALDI-IT-TOF, or MALDI-FTICR spectrometer in which a time from ionization to detection of ion is long. However, the conventional matrix 4-CHCA shows excellent measuring sensitivity and is advantageous in that an optimum spot on which a laser is to be focused can be easily found in a mass spectrometric sample.

On the other hand, the matrix 3H4NBA of the present invention can advantageously suppress the progression of self-disintegration of an analyte to be measured, and achieve efficient ionization of a hydrophobic analyte. The matrix 3H4NBA of the present invention is used in combination with 4-CHCA, thereby synergistic effect of the advantages given by both of the matrixes is exerted. In brief, an ability to detect with high sensitivity possessed by 4-CHCA is added while maintaining the advantages that 3H4NBA by itself have: suppression of self-disintegration of an analyte to be measured, and achievability of ionization of hydrophobic analyte, and it is possible to conduct a mass spectrometry with higher analytical efficiency.

According to the present invention, the applicable range of method capable of determining a sequence of a hydrophobic peptide (for example, NBS labeled peptide) is significantly increased. In a conventional technique, a MS/MS analysis by a mass spectrometer using an ESI (Electrospray Ionization) and a PSD analysis using a MALDI mass spectrometer were used. The present invention newly enabled a MS/MS analysis by a MALDI-IT mass spectrometer, a MALDI-IT-TOF mass spectrometer, a MALDI-FTICR mass spectrometer, and the like which can cause CID (collision induced dissociation). In addition, since CID can cause fragmentation more effectively than PSD, it became possible to improve the identification rate of peptides.

### EXAMPLES

The invention will now be explained more detail by way of examples, however, the present invention is not limited to these examples. As is mentioned above, the amount expressed as % in this description is on the basis of v/v % unless otherwise specified. In Examples, labeling with an NBS reagent is referred to as modification or NBS modification in some cases.

### Example 1

In this Example, measurement was conducted by means of a mass spectrometer using NBS modified peptides (a mixture of peptides modified with an NBS (heavy) reagent labeled with 6 stable isotope elements ¹³C and peptides modified with an unlabeled NBS (light) reagent) as a sample to be measured, using a matrix of 3-CHCA (α-cyano-3-hydroxycinnamic acid, Formula I) and 3H4NBA (3-hydroxy-4-nitrobenzoic acid, Formula II) of the present invention and using a conventional matrix DHB (2,5-dihydroxybenzoic acid, Formula IV) for comparison.

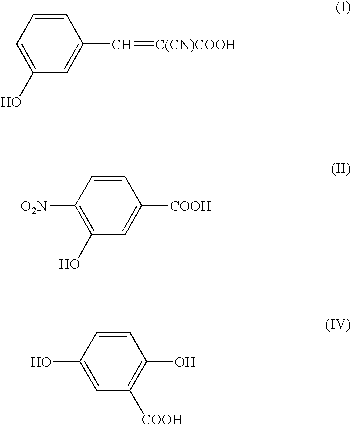

The sample to be measured was prepared in the following manner.

Two sample mixtures each having a total weight of 100 μg given by each 25 μg of four purified proteins (ovalbumin, glyceraldehyde-3-phosphate dehydrogenase, lysozyme, and α-lactalbumin, all available from SIGMA) was mixed were prepared. Samples to be measured were prepared in accordance with a protocol for “¹³CNBS Isotope Labeling Kit” (SHIMADZU) except that solubilization for each mixture and resolubilization for NBS-modified sample mixture were conducted using urea having a final concentration of 8M as a denaturing agent. One sample mixture of the two sample mixtures was modified with a NBS Reagent (heavy) (2-nitro[¹³C₆] benzenesulfenyl chloride) and the other sample mixture was modified with a NBS Reagent (light) (2-nitro[12 C₆] benzenesulfenyl chloride). Mixing of the both of the modified samples, desalting, resolubilization by urea, reduction, alkylation, and trypsin digestion were conducted.

Thereafter, the samples were lyophilized, suspended in 500 μl of 0.1% trifluoroacetic acid (TFA) aqueous solution, and loaded on a HiTrap Phenyl FF (high sub) column (Amersham Bioscience) equilibrated with 0.1% TFA aqueous solution. After washing this column with 3 ml of 0.1% TFA aqueous solution, 1 ml of 0.1% TFA aqueous solution containing 10% acetonitrile was used for elution. Then elution was similarly continued while varying the concentration of acetonitrile of TFA aqueous solution for elution from 15, 20, 25, 30, 35, and 40% in this order. Following the elution, the fraction eluted with 0.1% TFA aqueous solution containing 10% acetonitrile was lyophilized, resuspended in 50 μl of 0.1% TFA aqueous solution, and desalted with ZipTip (μC18). Thus a sample to be measured was obtained.

As the matrix, three kinds including 3-CHCA α-cyano-3-hydroxycinnamic acid, Formula I below) and 3H4NBA (3-hydroxy-4-nitrobenzoic acid, Formula II) of the present invention, and a conventional matrix DHB (2,5-hydroxybenzoic acid, Formula IV) for comparison were used.

The matrix for use was prepared in the following manner. Using 50% acetonitrile aqueous solution containing 0.1% TFA as a solvent, each of 3-CHCA, 3H4NBA and DHB was dissolved. DHB and 3-CHCA were prepared into respective solutions of 10 mg/ml, and 3H4NBA was prepared into a saturation solution.

Each 0.5 μl of the solution of a sample to be measured and the matrix solution obtained as described above was taken and mixed, and dropped on a target plate. After drying the solution, measurement was conducted using an AXIMA-QIT apparatus (MALDI-IT-TOF mass spectrometer, SHIMADZU).

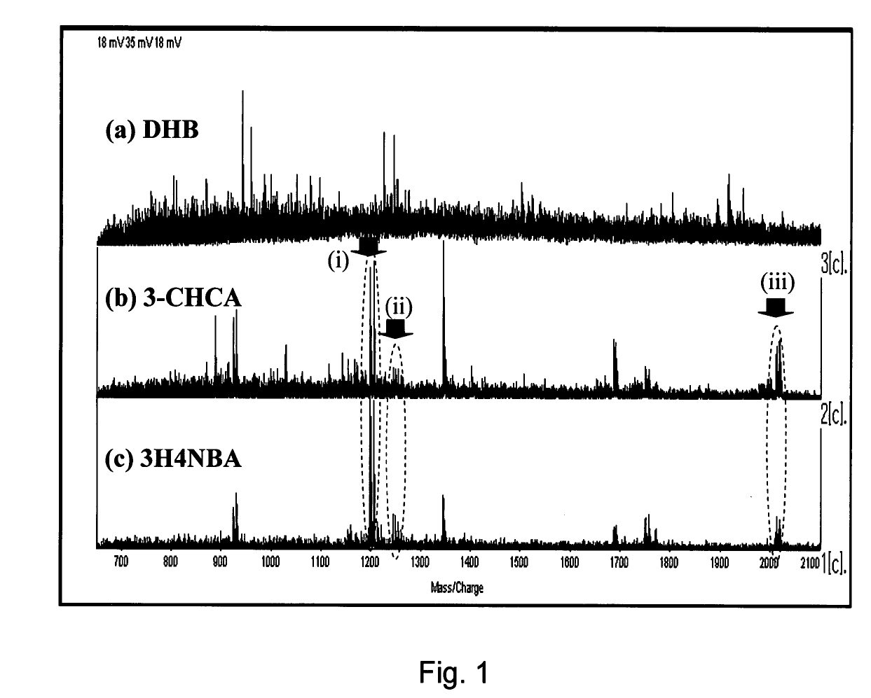

A MS spectrum obtained by the AXIMA-QIT apparatus is shown in FIG. 1. In FIG. 1, the horizontal axis represents mass-to-charge ratio, and the vertical axis represents relative intensity of ion. (a) is a spectrum of NBS-modified peptides when DHB was used as the matrix; (b) is a spectrum of NBS-modified peptides when 3-CHCA was used as the matrix; and (c) is a spectrum of NBS-modified peptides when 3H4NBA was used as the matrix. In the figure, (i), (ii), and (iii) indicate pair of peaks of NBS-modified peptide. Each pair of peaks were detected as a pair of peaks having a difference in m/z value of 6 that is corresponding to a difference in mass between the two modification reagents, that is, between the NBS Reagent (heavy) (2-nitro[¹³C₆] benzenesulfenyl chloride) and the NBS Reagent (light) (2-nitro[¹²C₆] benzenesulfenyl chloride).

Theoretical mass values and sequence corresponding to each pair of peaks and protein from which each pair of peaks are derived are as follows.
(i) 1198.53, 1204.55 (m/z), GTDVQAWIR (SEQ ID NO: 1), lysozyme.
(ii) 1244.51, 1250.53 (m/z), LDQWLCEK (SEQ ID NO: 2), α-lactalbumin.
(iii) 2011.95, 2017.97 (m/z), ELINSWVESQTNGIIR (SEQ ID NO: 3), ovalbumin

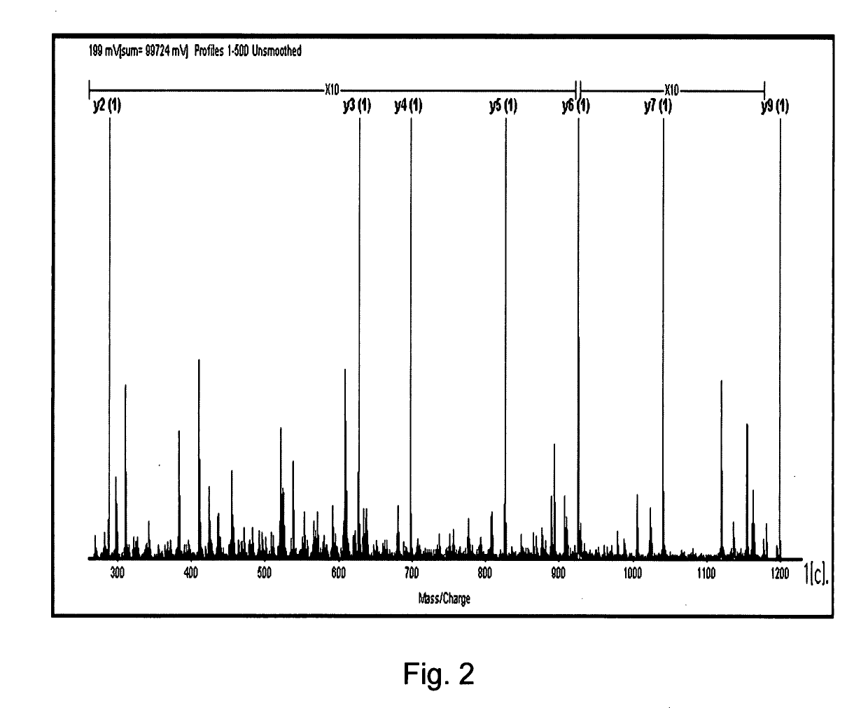

FIG. 2 is a fragment spectrum in a MS/MS analysis after selectively trapping the ion (GTDVQAWIR) corresponding to one of the paired peaks at m/z 1198.53 (i) in FIG. 1. In FIG. 2, the horizontal axis represents mass-to-charge ratio, and the vertical axis represents relative intensity of ion.

### Example 2

(a) Mass Spectrometric Measurement Using a Mass Spectrometer with an Ion Trap and a Mass Spectrometer Without an Ion Trap

Measurement was conducted by means of a mass spectrometers using a mixture of peptides modified with NBS reagent and unmodified peptides as a sample to be measured, and using a mixed matrix according to the present invention, namely a mixture of 3H4NBA (3-hydroxy-4-nitrobenzoic acid, Formula II) and conventional matrix of 4-CHCA (α-cyano-4-hydroxycinnamic acid, Formula III).

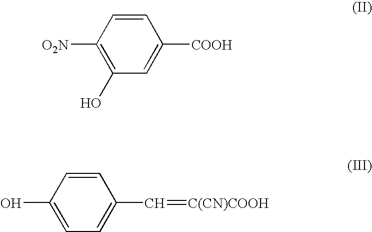

The sample to be measured was prepared in the following manner.

Two sample mixtures each having a total weight of 100 μg given by each 25 μg of four purified proteins (ovalbumin, glyceraldehyde-3-phosphate dehydrogenase, lysozyme, and α-lactalbumin, all available from SIGMA) was mixed were prepared. The protocol for “¹³CNBS Isotope Labeling Kit” (SHIMADZU) was followed except that each mixture was denatured using urea having a final concentration of 8M as a denaturing agent. Specifically, One of the two sample mixture was labeled-modified with a NBS Reagent (heavy) (2-nitro[¹³C₆] benzenesulfenyl chloride), and the other sample mixture was nonlabeled-modified with a NBS Reagent (light) (2-nitro[¹²C₆] benzenesulfenyl chloride). Mixing of the both of the modified samples, desalting, resolubilization by urea, reduction, alkylation, and trypsin digestion were conducted. The samples after digestion were conducted desalting treatment with ZipTip 1-C18, and eluting with 4 μl of 50% acetonitrile aqueous solution containing 0.1% TFA, to obtain a sample to be measured. 0.5 μl from this sample was applied on a target plate.

The matrix for use was prepared in the following manner. Each of 3H4NBA and 4-CHCA was dissolved in a solvent of 50% acetonitrile aqueous solution containing 0.1% TFA. 3H4NBA was prepared into a saturation solution, and 4-CHCA was prepared into a solution of 10 mg/ml. These solutions thus prepared were mixed with each other in a volume ratio of 1:1 to obtain a mixed matrix solution. On a prepared target plate on which a sample to be measured was applied, 0.5 μL of the mixed matrix solution was added. After drying, measurement was conducted using a MALDI-IT-TOF mass spectrometer having an ion trap (AXIMA-QIT, SHIMADZU) and a MALDI-TOF mass spectrometer without an ion trap (AXIMA-CFR plus, SHIMADZU).

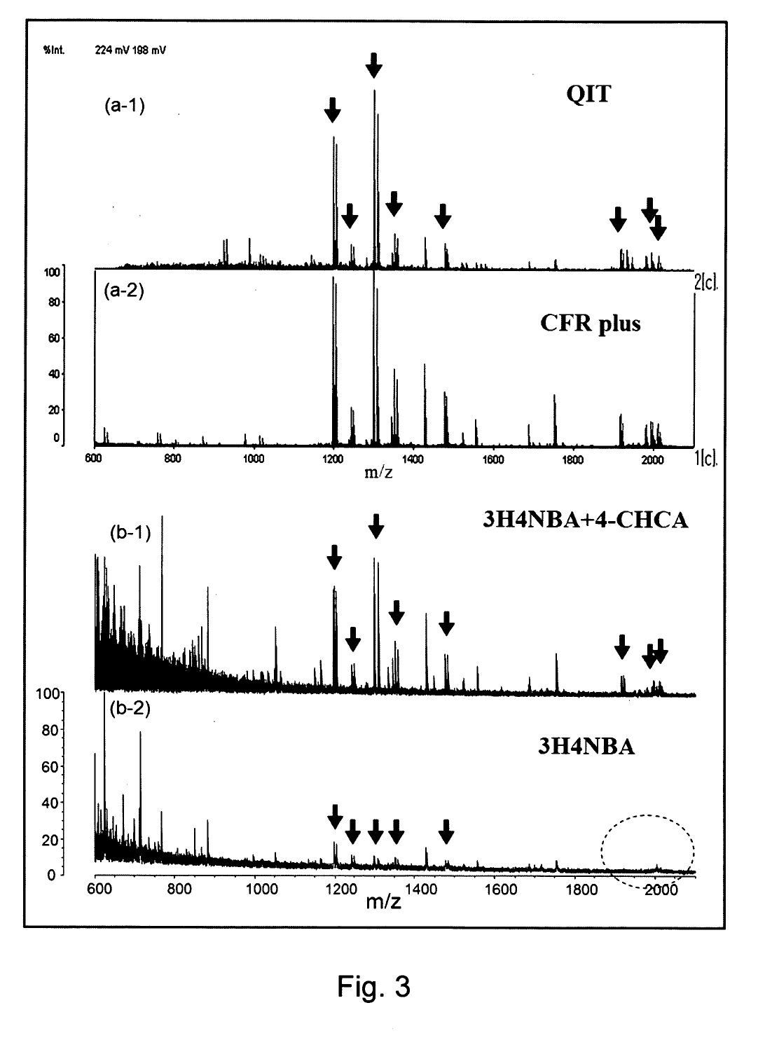

The MS spectra obtained in these measurements are shown in FIG. 3(a-1) and FIG. 3(a-2). In these figures, the horizontal axis represents mass-to-charge ratio (m/z), and the vertical axis represents relative intensity of ion (% int.). (a-1) is a spectrum obtained by using the AXIMA-QIT having an ion trap, and (a-2) is a spectrum obtained by using the AXIMA-CFR plus without an ion trap. Further, these figures show that the pairs of peaks marked with the arrows come from NBS-modified peptides. Each pair of peaks has a difference of m/z value of 6 that is corresponding to a difference in mass between the two modification reagents, that is, between the NBS Reagent (heavy) (2-nitro[¹³C₆] benzenesulfenyl chloride) and the NBS Reagent (light) (2-nitro[¹²C₆] benzenesulfenyl chloride).

As can be seen by comparison of the spectra of FIG. 3(a-1) and FIG. 3(a-2), almost the same spectrum was obtained. The fact that almost the same spectrum was obtained by a mass spectrometer having an ion trap and by a mass spectrometer without an ion trap indicates that self-disintegration of the analyte is suppressed in measurement using a mass spectrometer having an ion trap. This leads the conclusion that the matrix mixture of the present invention suppresses self-disintegration of an analyte to be measured that occurs during conventional measurement using a mass spectrometer with an ion trap (namely, mass spectrometer requiring relatively long time from ionization to detection of ion) using 4-CHCA alone as a matrix.

(b) Mass Spectrometry with a Matrix of 3H4NBA by Itself and a Mixed Matrix of 3H4NBA and 4-CHCA

Using the same sample to be measured as the above (a), a mass spectrometry was conducted with a matrix of 3H4NBA by itself and a mixed matrix of 3H4NBA and 4-CHCA which are the matrices of the present invention.

The same sample to be measured as used in the above (a) was diluted in 0.1% TFA aqueous solution to make a 1000-fold dilution, and 0.5 μl from the diluted solution was applied on a target plate.

As the matrix, a matrix of 3H4NBA by itself and a mixed matrix of 3H4NBA and 4-CHCA were used.

The matrix of 3H4NBA by itself was prepared as a saturated solution by dissolving 3H4NBA in 50% acetonitrile aqueous solution containing 0.1% TFA.

The mixed matrix of 3H4NBA and 4-CHCA was prepared in the same manner as in the above (a).

On a prepared target plate on which a sample to be measured was applied, the 3H4NBA solution or the mixed solution of 3H4NBA and 4-CHCA was applied. After drying, measurement was conducted using a MALDI-TOF (AXIMA-CFR plus, SHIMADZU).

The MS spectra obtained in these measurements are shown in FIG. 3(b-1) and FIG. 3(b-2). In these figures, the horizontal axis represents mass-to-charge ratio (m/z), and the vertical axis represents relative intensity of ion (%). (b-1) is a spectrum obtained by using the mixed matrix of 3H4NBA and 4-CHCA, and (b-2) is a spectrum obtained by using the 3H4NBA matrix. Further, these figures show that the pairs of peaks marked with the arrows come from NBS-modified peptides. Each pair of peaks has a difference of m/z value of 6 that corresponds to a difference in mass between the two modification reagents, that is, between the NBS Reagent (heavy) (2-nitro[¹³C₆] benzenesulfenyl chloride) and a NBS Reagent (light) (2-nitro[¹²C₆] benzenesulfenyl chloride).

As is apparent from comparison of spectra FIG. 3(b-1) and (b-2), the pairs of peaks of NBS-modified peptides are detected more sensitively in (b-1) than (b-2). This indicates that sensitivity is improved when as a matrix 3H4NBA is mixed with 4-CHCA. It was confirmed that advantages of 4-CHCA that “measurement with high sensitivity can realize” in the condition that “optimum spot on which a laser beam is to be focused can be readily found” are added while keeping the advantage of 3H4NBA that “hydrophobic sample can be detected by mass spectrometry.” In brief, it was confirmed that the advantage of 3H4NBA that “self-disintegration of sample can be suppressed even if measurement is conducted using an ion trap MALDI mass spectrometer in which the time from ionization to detection of ion is relatively long” and the advantage of 4-CHCA “measurement with high sensitivity can realize” in the condition that “optimum spot on which a laser beam is to be focused can be readily found” were achieved simultaneously.

The above-described Examples show concrete two modes within the scope of the present invention, however, the present invention can be carried out in various other modes. Therefore, the above-described Examples are merely illustrative in all respects, and must not be construed as being restrictive. Further, the changes that fall within the equivalents of the claims are all within the scope of the present invention.

1. A method of measuring a peptide with a mass spectrometer having a MALDI (Matrix Assisted Laser Desorption/Ionization) ion source, using α-cyano-3-hydroxycinnamic acid or 3-hydroxy-4-nitrobenzoic acid as a matrix.

2. The method of measuring a peptide according to claim 1, wherein when 3-hydroxy-4-nitrobenzoic acid is used as the matrix, the measuring is performed by using a mixed matrix of 3-hydroxy-4-nitrobenzoic acid and α-cyano-4-hydroxycinnamic acid.

3. The method of measuring a peptide according to claim 1, wherein the peptide is a peptide that is chemically modified with a hydrophobic compound.

4. The method of measuring a peptide according to claim 1, wherein the peptide is a peptide that has an amino acid residue modified with a sulfenyl compound.

5. The method of measuring a peptide according to claim 1, wherein the peptide is a peptide that is derivatized with 2-nitrobenzenesulfenyl chloride.

6. The method of measuring a peptide according to claim 1, performed by a MALDI-IT (Matrix Assisted Laser Desorption/Ionization—Ion Trap) mass spectrometer.

7. The method of measuring a peptide according to claim 1, performed by a MALDI-IT-TOF (Matrix Assisted Laser Desorption/Ionization—Ion Trap—Time of Flight) mass spectrometer.

8. The method of measuring a peptide according to claim 1, performed by a MALDI-FTICR (Matrix Assisted Laser Desorption/Ionization—Fourier Transform Ion Cyclotron Resonance) mass spectrometer.

9. The method of measuring a peptide according to claim 1, wherein the matrix is used as a solution having a concentration of 1 mg/ml to a saturated concentration.

10. The method of measuring a peptide according to claim 2, wherein the α-cyano-4-hydroxycinnamic acid is used as a solution having a concentration of 1 mg/ml to a saturated concentration.

11. The method of measuring a peptide according to claim 10, wherein the solution of 3-hydroxy-4-nitrobenzoic acid and the solution of α-cyano-4-hydroxycinnamic acid are used in combination in a volume ratio of 1:10 to 10:1.
